(19) United States
(12) Patent Application Publication
(10) Pub. No.: US 2015/0244288 A1
(43) Pub. Date: Aug. 27, 2015

(54) INVERTING APPARATUS

(71) Applicant: FSP TECHNOLOGY INC., Taoyuan City (TW)

(72) Inventors: Han-Wei Chen, Taoyuan City (TW); Chun-Hao Yu, Taoyuan City (TW); Chia-Hua Liu, Taoyuan City (TW)

(21) Appl. No.: 14/631,845

(22) Filed: Feb. 26, 2015

Related U.S. Application Data
(60) Provisional application No. 61/944,587, filed on Feb. 26, 2014.

(30) Foreign Application Priority Data
Feb. 5, 2015 (TW) 104103879

(51) Int. Cl. H02M 7/5387

(52) U.S. Cl. CPC H02M 7/5387

(57) ABSTRACT

An inverting apparatus including an inverting circuit and a control circuit is provided. The inverting circuit has a first bridge arm unit, a second bridge arm unit, and an energy charging/discharging unit. The energy charging-discharging unit is coupled between the first bridge and the second bridge arm units. The first bridge ail 1 unit is switched according to a first and a second control signals and the second bridge arm unit is switched according to a third and a fourth control signals, so as to converts a DC input voltage into an AC output voltage. The control circuit controls the power conversion of the inverting circuit by the control signals. The control circuit samples magnetizing currents flow through the first and the second bridge arm units so as to adjust switch timing of the control signals, and thus the inverting circuit is operated at the boundary conduction mode (BCM).

### CROSS-REFERENCE TO RELATED APPLICATION

This application claims the priority benefits of U.S. provisional application Ser. No. 61/944,587, filed on Feb. 26, 2014 and Taiwan application serial no. 104103879, filed on Feb. 5, 2015. The entirety of each of the above-mentioned patent applications is hereby incorporated by reference herein and made a part of this specification.

### BACKGROUND

1. Field of the Invention

The invention is directed to a power conversion technique and more particularly, to an inverting apparatus operated in a boundary conduction mode (BCM).

2. Description of Related Art

As for a general type DC-to-AC inverting apparatus, a structure including a plurality of active devices is applied, which achieves power conversion by means of switches the active devices. However, the switching of the active devices will result in distortion of an input current to produce a great amount of harmonic waves. Besides, a typical hard-switching means also causes significant switching loss to the active devices during the switching, such that the overall conversion efficiency of the inverting apparatus is hard to be improved.

In a currently adopted technique, a designer can mitigate the switching loss of the active devices by means of soft-switching control. For instance, a generally used soft-switching control means may be classified into two types, zero voltage switching-on (ZVS) and zero current switching-on(ZCS) No matter whether the ZVS or the ZCS means is used, the active device can be substantially prevented from producing energy loss during the switching process.

Nevertheless, in order to achieve the soft-switching control mechanism, auxiliary circuits or damping circuits have to be additionally configured in an inverting circuit in most cases, but the additionally configured circuits lead to increased design complexity and cost in the inverting circuit.

### SUMMARY

The invention provides an inverting apparatus capable of utilizing a simple circuit structure to achieve zero voltage switching on of an active device, such that the inverting apparatus is operated in a boundary conduction mode (BCM), so as to enhance conversion efficiency of the inverting apparatus.

According to an embodiment, the invention is directed to an inverting apparatus including an inverting circuit and a control circuit. The inverting circuit has a first bridge arm unit, a second bridge arm unit and an energy charging/discharging unit. The energy charging/discharging unit is coupled between the first bridge arm unit and the second bridge arm unit, and the energy charging/discharging unit is adapted to connect an electrical grid in parallel, so as to provide an AC output voltage. The first bridge arm unit and the second bridge arm unit receive a DC input voltage, the first bridge arm unit is switched according to a first control signal and a second control signal, and the second bridge arm unit is switched according to a third control signal and a fourth control signal, so as to convert the DC input voltage into the AC output voltage. The control circuit is coupled to the inverting circuit and configured to provide the first through the fourth control signals to control power conversion of the inverting circuit. The control circuit samples a first magnetizing current flowing through the first bridge arm unit and a second magnetizing current flowing through the second bridge arm unit to adjust switch timing of the first through the fourth control signals, such that the inverting circuit is operated on a BCM.

In an embodiment of the invention, the control circuit determines whether the first magnetizing current reaches a preset reverse current peak, and the second magnetizing current reaches a preset positive current peak, so as to adjust the switch timing of the first through the fourth control signals according to the determination result.

In an embodiment of the invention, the inverting circuit includes a first transistor, a second transistor, a first resistor, a third transistor, a fourth transistor, a second resistor, a magnetizing inductor and a storage capacitor. A first terminal of the first transistor receives the DC input voltage, and a control terminal of the first transistor receives the first control signal. A first terminal of the second transistor is coupled to a second terminal of the first transistor, and a control terminal of the second transistor receives the second control signal. A first terminal of the first resistor is coupled to a second terminal of the second transistor, and a second terminal of the first resistor is coupled to a ground terminal, wherein the first transistor, the second transistor and the first resistor form the first bridge arm unit, and a current flowing through the first resistor is defined as the first magnetizing current. A first terminal of the third transistor receives the DC input voltage, and a control terminal of the third transistor receives the third control signal. A first terminal of the fourth transistor is coupled to a second terminal of the third transistor, and a control terminal of the fourth transistor receives the fourth control signal. A first terminal of the second resistor is coupled to a second terminal of the fourth transistor, and a second terminal of the second resistor is coupled to the ground terminal, wherein the third transistor, the fourth transistor and the second resistor form the second bridge arm unit, and a current flowing through the second resistor is defined as the second magnetizing current. A first terminal of the magnetizing inductor is coupled to the second terminal of the first transistor and the first terminal of the second transistor. A first terminal of the storage capacitor is coupled to a second terminal of the magnetizing inductor, and a second terminal of the storage capacitor is coupled to the second terminal of the third transistor and the first terminal of the fourth transistor wherein the magnetizing inductor and the storage capacitor form the energy charging/discharging unit on-states of the first through the fourth transistors are switched respectively in response to the received first through fourth control signals, such that the magnetizing inductor and the storage capacitor store or release electric energy in response to the switching of the first through the fourth transistors, so as to generate the AC output voltage at the two terminals of the storage capacitor.

In an embodiment of the invention, the control circuit includes a micro-controller, a first comparator, a second comparator and a third comparator. The micro-controller is configured to generate the first through the fourth control signals and switch disable/enable states of the first through the fourth control signals according to a first comparison signal and a second comparison signal. A first input terminal of the first comparator is coupled to the first terminal of the first resistor and the first terminal of the second resistor, a second input terminal of the first comparator receives a first preset voltage indicating a first preset current, and an output terminal of the first comparator outputs the first comparison signal, wherein the first comparison signal indicates a result of comparing the first magnetizing current with the first preset current or a result of comparing the second magnetizing current with the first preset current. A first input terminal of the second comparator is coupled to the first terminal of the first resistor and the first terminal of the second resistor, a second input terminal of the second comparator receives a second preset voltage indicating a second preset current, and an output terminal of the second comparator outputs the second comparison signal, wherein the second comparison signal indicates a result of comparing the first magnetizing current with the second preset current or a result of comparing the second magnetizing current with the second preset current.

In an embodiment of the invention, the inverting circuit further includes a zero-voltage detection unit. The zero-voltage detection unit includes a first detection capacitor, a third detection capacitor and a fourth detection capacitor. A first terminal of the first detection capacitor is coupled to the second terminal of the first transistor, the first terminal of the second transistor and the first terminal of the magnetizing inductor. A first terminal of the third detection capacitor is coupled to a second terminal of the first detection capacitor. A first terminal of the fourth detection capacitor is coupled to a second terminal of the third detection capacitor, and a second terminal of the fourth detection capacitor is coupled to the ground terminal, wherein the a current flowing through the fourth detection capacitor is defined as a first detection current.

In an embodiment of the invention, the inverting circuit further has the zero-voltage detection unit. The zero-voltage detection unit further includes a second detection capacitor, a fifth resistor and a sixth resistor. A first terminal of the second detection capacitor is coupled to the second terminal of the third transistor, the first terminal of the fourth transistor and a second terminal of the storage capacitor. A first terminal of the fifth resistor is coupled to a second terminal of the second detection capacitor. A first terminal of the sixth resistor is coupled to a second terminal of the fifth resistor. A second terminal of the sixth resistor is coupled to the ground terminal, wherein a current flowing through the sixth resistor is defined as a second detection current.

In an embodiment of the invention, the micro-controller further switches the disable/enable states of the first through the fourth control signals according to a third comparison signal and a fourth comparison signal, and the control circuit further includes a third comparator and a fourth comparator. A first input terminal of the third comparator is coupled to the first terminal of the fourth detection capacitor, a second input terminal of the third comparator receives a third preset voltage indicating a third preset current, and an output terminal of the third comparator outputs the third comparison signal, wherein the third comparison signal indicates a result of comparing the first detection current with the third preset current. A first terminal of the fourth comparator is coupled to the first terminal of the sixth resistor, a second input terminal of the fourth comparator receives a fourth preset voltage indicating a fourth preset current, and an output terminal of the fourth comparator outputs the fourth comparison signal, wherein the fourth comparison signal indicating a result of comparing the second detection current with the fourth preset current.

In an embodiment of the invention, when the inverting circuit is operated in a first power conversion stage, the micro-controller generates the enabled first and fourth control signals and the disabled second and third control signals, so as to switch on the first and the fourth transistors and switch off the second and the third transistors. When determining that the first magnetizing current or the second magnetizing current is greater than the first preset current according to the first comparison signal, the micro-controller switches the first control signal to be disabled, such that the inverting circuit enters a second power conversion stage.

In an embodiment of the invention, when the inverting circuit is operated in the second power conversion stage, the micro-controller generates the enabled fourth control signal and the disabled first through third control signals, so as to switch on the fourth transistor and switch off the first through the third transistors. The micro-controller switches the second control signal to be enabled after a preset time period, such that the inverting circuit enters a third power conversion stage.

In an embodiment of the invention, when the inverting circuit is operated in the third power conversion stage, the micro-controller generates the enabled second and fourth control signals and the disabled first and third control signals, so as to switch on the second and the fourth transistors and switch off the first and the third transistors. When determining that the first magnetizing current or the second magnetizing current is greater than the second preset current according to the second comparison signal, the micro-controller switches the second control signal to be disabled, such that the inverting circuit enters a fourth power conversion stage.

In an embodiment of the invention, when the inverting circuit is operated in the fourth power conversion stage, the micro-controller generates the enabled fourth control signal and the disabled first through third control signals, so as to switch on the fourth transistor and switch off the first through the third transistors. When determining that the first detection current is greater than the third preset current according to third comparison signal, the micro-controller switches the first control signal to be enabled, such that the inverting circuit enters the first power conversion stage.

In an embodiment of the invention, the first through the fourth transistors are controlled by the micro-controller control to switch the on state when having zero voltage.

To sum up, the inverting apparatus provided by the embodiments of the invention can determine whether the magnetizing current flowing through each bridge arm reaches the preset positive current peak or the preset reverse current peak, so as to adjust the switch timing of the control signals. Thereby, each transistor in the inverting circuit can achieve the zero voltage switching-on (ZVS), and the inverting circuit can be operated in the BCM for the power conversion. Therefore, based on the premise that the circuit structure does not need any change, the inverting apparatus provided by the embodiments of the invention can achieve the enhancement of conversion efficiency of the inverting apparatus only by means of the control circuit regulating the circuit operations of the inverting circuit.

In order to make the aforementioned and other features and advantages of the invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic block diagram illustrating an inverting apparatus according to an embodiment of the invention.

FIG. 2 is a schematic circuit diagram illustrating the inverting apparatus according to an embodiment of the invention.

FIG. 3A through FIG. 3D are schematic diagrams illustrating equivalent circuits of the inverting apparatus operated in different power conversion stages according to an embodiment of the invention.

FIG. 4 is a schematic waveform chart illustrating a voltages and a current of the inverting apparatus according to an embodiment of the invention.

### DESCRIPTION OF EMBODIMENTS

In order to make the content of the invention clearer, the following embodiments are illustrated as examples that can be truly implemented by the invention. Wherever possible, the same reference numbers are used in the drawings and the description to refer to the same or like parts.

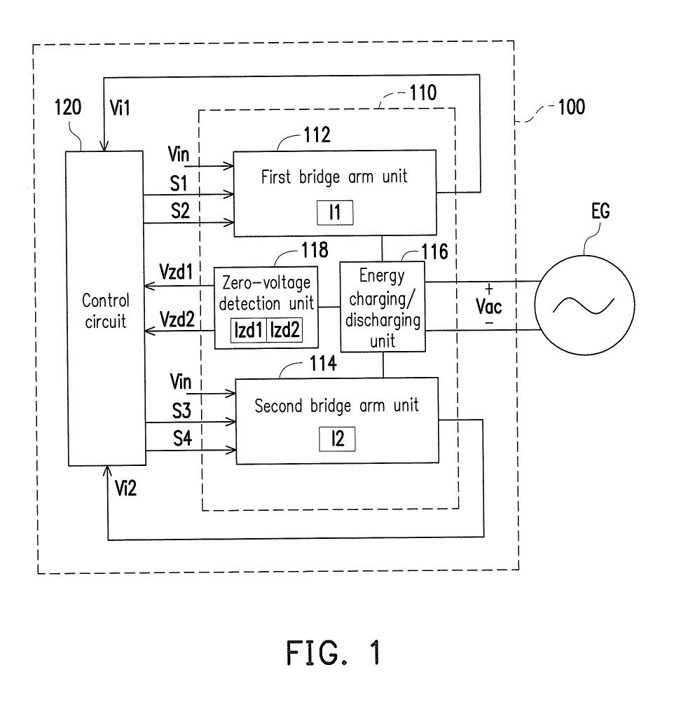

FIG. 1 is a schematic block diagram illustrating an inverting apparatus according to an embodiment of the invention. With reference to FIG. 1, an inverting apparatus 100 of the present embodiment is adapted to be applied in an AC power system. In the AC power system, the inverting apparatus 100 may receive DC input power from a front-end DC power generating apparatus (not shown), so as to generate AC output power to a back-end electrical grid EG and/or a load (not shown). In this circumstance, the DC power generating apparatus may be a photovoltaic module, a wind power module, a hydropower module or any other type of the DC power generating apparatus, which is not limited in the invention.

The inverting apparatus 100 receives a DC input voltage Vin generated by the DC power generating apparatus and accordingly, converts the DC input voltage Vin into an AC output voltage Vac to the back-end electrical grid EG which is connected in parallel therewith. The inverting apparatus 100 includes an inverting circuit 110 and a control circuit 120.

The inverting circuit 110 has a first bridge arm unit 112, a second bridge arm unit 114 and an energy charging/discharging unit 116. The energy charging/discharging unit 116 is coupled between the first bridge arm unit 112 and the second bridge arm unit 114. The energy charging/discharging unit 116 is adapted to connect the electrical grid EG in parallel, so as to provide the AC output voltage Vac. In the present embodiment, the first bridge arm unit 112 and the second bridge arm unit 114 may be composed of an upper-arm active device and a lower-arm active device (whose specific circuit structure will be described below). Additionally, the inverting circuit 110 further includes a zero-voltage detection unit 118. The zero-voltage detection unit 118 is coupled to the energy charging/discharging unit 116 and may generate detection currents Izd1 and Izd2 in response to circuit switching of the first bridge arm unit 112 and the second bridge arm unit 114.

The control circuit 120 is coupled to the inverting circuit 110 and configured to provide control signals S1 through S4 to control power conversion operation of the inverting circuit 110. The control signals S1 through S4 may be, for example, pulse width modulation (PWM) signals for controlling a switching cycle of the inverting circuit 110. Therein, changes in levels of the control signals S1 through S4 may serve to control on and off states of the corresponding upper-arm active device and /or lower-arm active device, so as to control the overall operation of the inverting circuit 110. In addition, the control circuit 120 may determine a zero voltage time point of the upper-arm active device according to the detection currents Izd1 and Izd2 of the zero-voltage detection unit 118 and thereby, adjust the provided control signals S1 through S4.

Specifically, after the first bridge arm unit 112 and the second bridge arm unit 114 receive the DC input voltage Vin, the first bridge arm unit 112 is switched according to the control signals S1 and S2, and the second bridge arm unit 114 is switched according to the control signals S3 and S4, such that the DC input voltage Vin is converted into the AC output voltage Vac.

Therein, the control circuit 120 samples a magnetizing current I1 flowing through the first bridge arm unit 112 and a magnetizing current I2 flowing through the second bridge arm unit 114, so as to adjust switch timing of the control signals S1 through S4. In the present embodiment, the specific operation of the control circuit 120 sampling the magnetizing currents I1 and I2 may be respectively implemented by means of the first bridge arm unit 112 receiving a current-indicating voltage Vi1 associated with the magnetizing current I1 and the second bridge arm unit 114 receiving a current-indicating voltage Vi2 associated with the magnetizing current I2, but the invention is not limited thereto.

To be more specific, in the aforementioned control means, the control circuit 120 may determine whether the magnetizing currents I1 and I2 respectively reaches a preset reverse current peak and a preset positive current peak, so as to adjust the switch timing of the control signals S1 through S4 according to the determination result. Thereby, each active device in the first bridge arm unit 112 and the second bridge arm unit 114 may achieve zero voltage switching-on (ZVS), and the inverting circuit 110 may be operated in a boundary conduction mode (BCM) for power conversion. Therefore, on a premise that the circuit structure does not need to be changed, the inverting apparatus 100 may regulate circuit operations of the inverting circuit 110 to enhance conversion efficiency of the inverting apparatus 100 only by means of utilizing the control circuit 120.

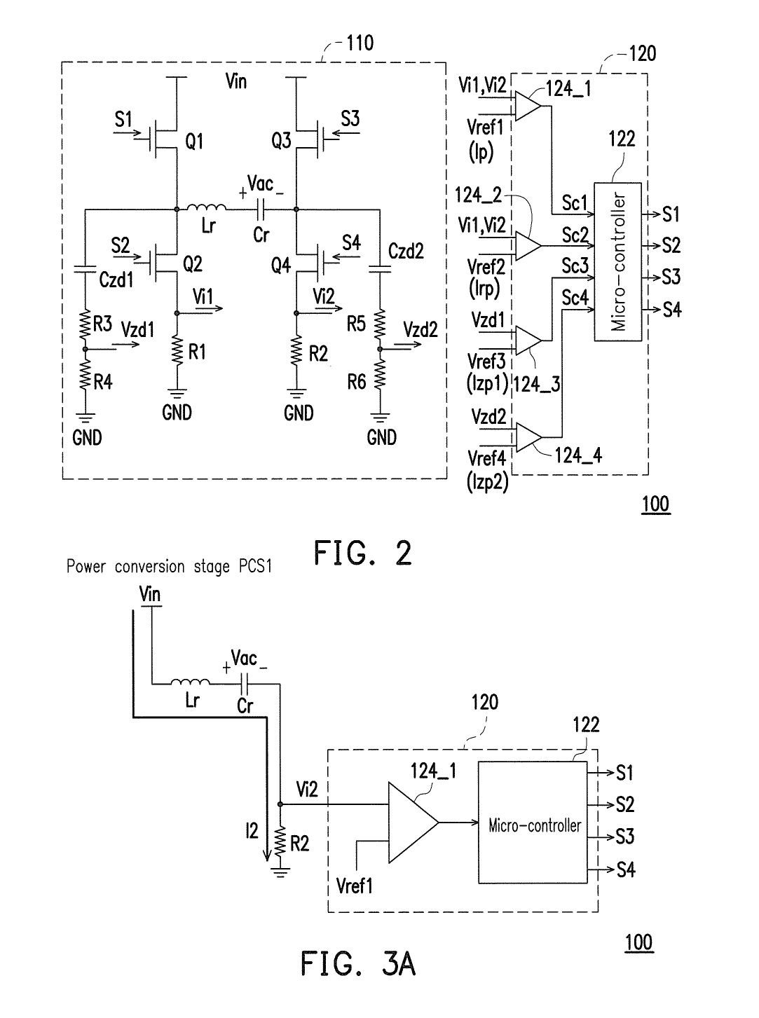

The specific circuit structure of the inverting apparatus 100 of the invention will be described with reference to FIG. 2. FIG. 2 is a schematic circuit diagram illustrating the inverting apparatus according to an embodiment of the invention.

With reference to both FIG. 1 and FIG. 2, in the present embodiment, the inverting circuit 110 includes transistors Q1 through Q4, resistors R1 through R6, magnetizing inductor Lr, a storage capacitor Cr and detection capacitors Czd1 and Czd2. Additionally, the control circuit 120 includes a micro-controller 122 and comparators 124_1 through 124_4.

In the inverting circuit 110 of the present embodiment, the transistors Q1 and Q2 and the resistor R1 form the first bridge arm unit 112 (where the transistors Q1 and Q2 may be respectively considered as the upper-arm active device and the lower-arm active device of the first bridge arm unit 112), and the transistors Q3 and Q4 and the resistor R2 form the second bridge arm unit 114 (where the transistors Q3 and Q4 may be respectively considered as the upper-arm active device and the lower-arm active device of the second bridge arm unit 114). Therein, a current flowing through the resistor R1 is defined as the magnetizing current I1, and a current flowing through the resistor R2 is defined as the magnetizing current I2. The magnetizing inductor Lr and the storage capacitor Cr form the energy charging/discharging unit 114, where the AC output voltage Vac generated by the inverting circuit 110 is a cross-voltage of the storage capacitor Cr. The detection capacitors Czd1 and Czd2 and the resistors R3 through R6 form the zero-voltage detection unit 118, and currents flowing through the resistors R4 and R6 are respectively defined as the detection currents Izd1 and Izd2.

Foe descriptive convenience, all the transistors Q1 through Q4 in the present embodiment are illustrated as N-type MOS transistors as implementation examples to describe circuit connection configurations of the inverting circuit 110, which construes no limitations to the invention.

In the first bridge arm unit 112, a drain of the transistor Q1 receives the DC input voltage Vin, and a gate of the transistor Q1 is coupled to the micro-controller 122 to receive the control signal S1. A drain of the transistor Q2 is coupled to a source of the transistor Q1, and a gate of the transistor Q2 is coupled to the micro-controller 122 to receive the control signal S2. A first terminal of the resistor R1 is coupled to a source of the transistor Q2, and a second terminal of the resistor R1 is coupled to a ground terminal GND.

In the second bridge arm unit 114, a drain of the transistor Q3 receives the DC input voltage Vin, and a gate of the transistor Q3 is coupled to the micro-controller 122 to receive the control signal S3. A drain of the transistor Q4 is coupled to a source of the transistor Q3, and a gate of the transistor Q4 is coupled to the micro-controller 122 to receive the control signal S4. A first terminal of the resistor R2 is coupled to a source of the transistor Q4, and a second terminal of the resistor R2 is coupled to the ground terminal GND.

In other words, in the present embodiment, circuit structures of the first bridge arm unit 112 and the second bridge arm unit 114 are symmetrically configured.

In the energy charging/discharging unit 116, the magnetizing inductor Lr and the storage capacitor Cr are connected in serial and coupled between the first bridge arm unit 112 and the second bridge arm unit 114. A first terminal of the magnetizing inductor Lr is coupled to the source of the transistor Q1 and the drain of the transistor Q2. A first terminal of the storage capacitor Cr is coupled to a second terminal of the magnetizing inductor Lr, and a second terminal of the storage capacitor Cr is coupled to the source of the transistor Q3 and the drain of the transistor Q4.

In the zero-voltage detection unit 118, the detection capacitor Czd1, the resistor R3 and the resistor R4 are connected in serial as a set for zero voltage detection, and the detection capacitor Czd2, the resistor R5 and the resistor R6 are connected in serial as another set for zero voltage detection. A first terminal of the detection capacitor Czd1 is coupled to the source of the transistor Q1, the drain of the transistor Q2 and the first terminal of the magnetizing inductor Lr. A first terminal of the resistor R3 is coupled to a second terminal of the detection capacitor Czd. A first terminal of the resistor R4 coupled to second terminal of the resistor R3, and a second terminal of the resistor R4 is coupled to the ground terminal GND. A first terminal of the detection capacitor Czd2 is coupled to the source of the transistor Q3, the drain of the transistor Q4 and the second terminal of the storage capacitor. A first terminal of the resistor R5 is coupled to a second terminal of the detection capacitor Czd2. A first terminal of the resistor R6 is coupled to a second terminal of the resistor R5, and a second terminal of the resistor R6 is coupled to the ground terminal GND.

According to the operation of the power conversion of the inverting circuit 110, the on-state of each of the transistors Q1 through Q4 is switched in response to the received control signals S1 through S4, such that the magnetizing inductor Lr and the storage capacitor Cr store or release electric energy in response to the switching of the transistors Q1 through Q4, and the AC output voltage Vac is generated at the two terminals of the storage capacitor Cr.

On the other hand, in the control circuit 120, each of the comparators 124 _1 through 124_4 has a first input terminal, a second input terminal and an output terminal. The first input terminal of the comparator 124_1 is coupled to the first terminals of the resistor R1 and R2, so as to receive the current-indicating voltages Vi1 and Vi2 indicating sizes of the magnetizing currents I1 and I2 in a forward direction (which is defined as a direction of the first terminal of the magnetizing inductor Lr pointing to the second terminal). The second input terminal of the comparator 124_1 receives a preset voltage Vref1 indicating a preset current Ip. The output terminal of the comparator 124_1 outputs a comparison signal Sc1, where the comparison signal Sc1 is configured to indicate a result of comparing the forward-direction magnetizing currents I1 and I2 with the preset current Ip.

The first input terminal of the comparator 124_2 is coupled to the first terminals of the resistor R1 and R2, so as to receive the current-indicating voltages Vi1 and Vi2 indicating the sizes of the magnetizing currents I1 and I2 in a reverse direction (which is defined as a direction of the second terminal of the magnetizing inductor Lr pointing to the first terminal). The second input terminal of the comparator 124_2 receives a preset voltage Vref2 indicating a preset current Irp. The output terminal of the comparator 124_2 outputs a comparison signal Sc2, where the comparison signal Sc2 is configured to indicate a result of comparing the reverse magnetizing currents I1 and I2 with the preset current Irp.

The first input terminal of the comparator 124_3 is coupled to the first terminal of the resistor R4, so as to receive a current-indicating voltage Vzd1 indicating a size of the detection current Izd1. The second input terminal of the comparator 124_3 receives a preset voltage Vref3 indicating a preset current Izp1. The output terminal of the comparator 124_3 outputs a comparison signal Sc3, wherein the comparison signal Sc3 is configured to indicate a result of comparing the detection current Izd1 with the preset current Izp1.

The first input terminal of the comparator 124_4 is coupled to the first terminal of the resistor R6, so as to receive a current-indicating voltage Vzd2 indicating a size of the detection current Izd2. The second input terminal of the comparator 124_4 receives a preset voltage Vref4 indicating a preset current Izp2. The output terminal of the comparator 124_4 outputs a comparison signal Sc4, where the comparison signal Sc4 is configured to indicate a result of comparing the detection current Izd2 with the preset current Izp2.

The micro-controller 122 is configured to generate the control signals S1 through S4 and switch disable/enable states of the control signals S1 through S4 respectively according to the comparison signal Sc1 through Sc4.

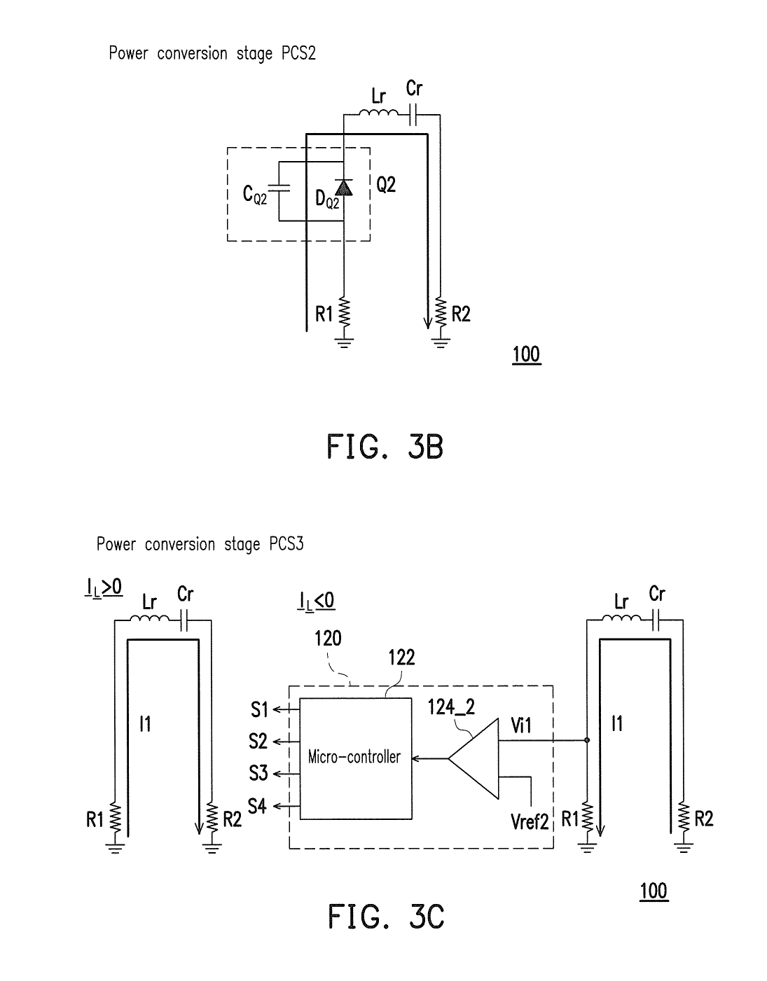

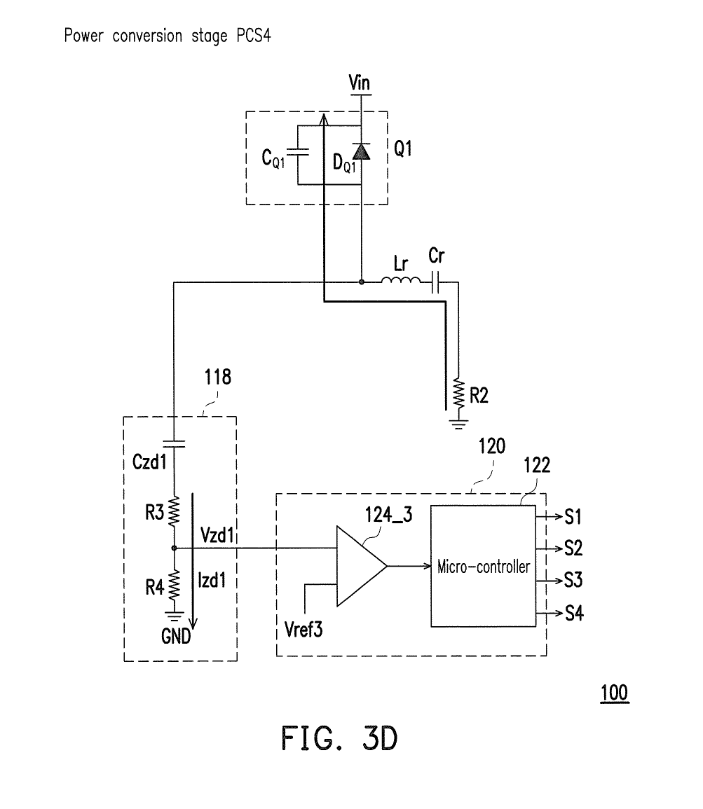

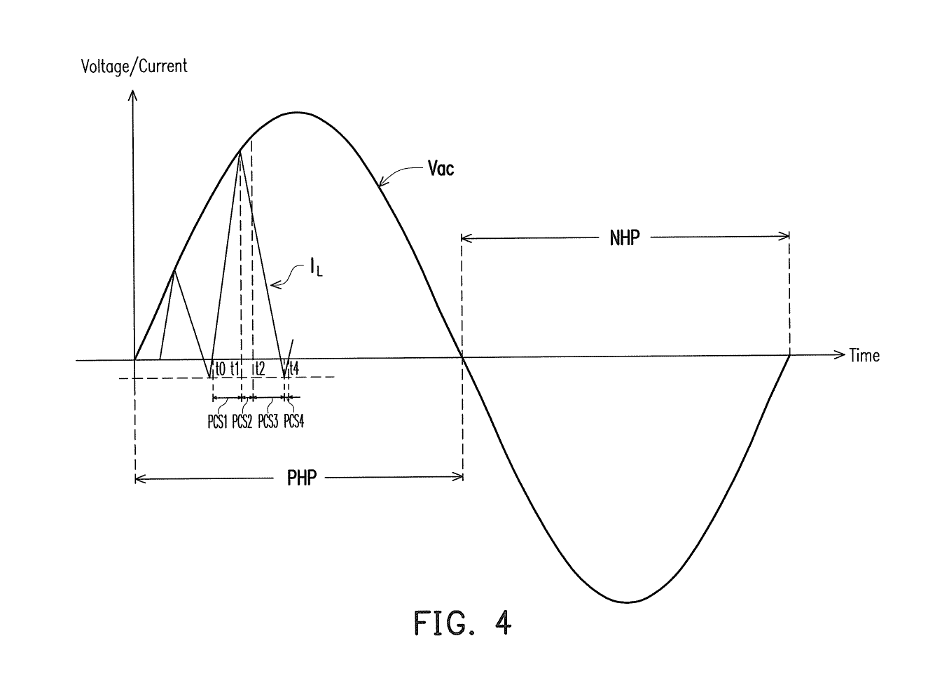

Hereinafter, the power conversion operation of the inverting apparatus 100 will be specifically described with reference to equivalent circuits illustrated in FIG. 3A through FIG. 3D and a voltage/current waveform illustrated in FIG. 4. FIG. 3A through FIG. 3D are schematic diagrams illustrating equivalent circuits of the inverting apparatus 100 operated in different power conversion stages PCS1 through PCS4. FIG. 4 is a schematic waveform chart illustrating the AC output voltage Vac and an inductive current I_{L} flowing through the magnetizing inductor Lr.

In the present embodiment, circuit operation of the AC output voltage Vac during a positive half cycle PHP is described. During the positive half cycle PHP, the inverting apparatus 100 is cyclically operated in four different power conversion stages PCS1 through PCS4 in response to the disable/enable states of the control signals S1 through S4. Herein, Table (1) is used to describe the disable/enable states of the control signals S1 through S4 in the power conversion stages PCS1 through PCS4:

TABLE (1)

| | PCS1 | PCS2 | PCS3 | PCS4 |
|---|---|---|---|---|
| S1 (Q1) | H | L | L | L |
| S2 (Q2) | L | L | H | L |
| S3 (Q3) | L | L | L | L |
| S4 (Q4) | H | H | H | H |

It is to be mentioned first that since all the transistors Q1 through Q4 are illustrated as N-type MOS transistors as implementation examples, a high level (represented by “H”) of each of the control signals S1 through S4 indicates the enable state, and a low level (represented by “L”) of each of the control signals S1 through S4 indicates the disable state. Namely, the transistors Q1 through Q4 are enabled/switched on in response to the control signals S1 through S4 in the high level H and disabled/switched off in response to the control signals S1 through S4 in the low level L, but the invention is not limited thereto. It should be understood to the persons of the art that if the transistors Q1 through Q4 are implemented by selecting P-type MOS transistors or any other type of active devices, the settings of the control signals S1 through S4 should be correspondingly adjusted.

Referring to FIG. 3A and FIG. 4 first, the inductive current I_{L} is changed from a reverse current to a forward current at a time point to. Therein, during the positive half cycle PHP, a current flowing from the first terminal of the magnetizing inductor Lr to the second terminal is defined as a forward current, and a current flowing from the second terminal of the magnetizing inductor Lr to the first terminal is defined as a reverse current. The inverting circuit 110 enters the power conversion stage PCS1 at the time point t0 when having zero current.

When the inverting circuit 110 is operated in the power conversion stage PCS1, the micro-controller 122 generates the control signals S1 and S4 in the high level H and the control signals S2 and S3 in the low level L, such that the transistors Q1 and Q4 are switched on in response to the control signals S1 and S4, and the transistors Q2 and Q3 are switched off in response to the control signals S2 and S3.

In the equivalent circuit configuration in this stage, the inverting circuit 110 establishes a current path between the DC input voltage Vin and the ground terminal GND. The current path is formed by the transistor Q1, the magnetizing inductor Lr, the storage capacitor Cr, the transistor Q4 and the resistor R2 in sequence.

The magnetizing inductor Lr magnetizes, and the storage capacitor Cr stores energy in response to the DC input voltage Vin, such that the magnetizing current I2 in the inductive current Lr is gradually increased in the power conversion stage PCS1. During the stage, the current-indicating voltage Vi2 rises as the forward-direction magnetizing current I2 rises. The comparator 124_1 continuously compares the current-indicating voltage Vi2 with the preset voltage Vref1, so as to determine whether the magnetizing current I2 is greater than the preset current Irp.

When determining that the magnetizing current I2 is greater than the preset current Irp according to the comparison signal Sc1 at a time point t1, the micro-controller 122 switches the control signal S1 to be in the low-level L, such that the inverting circuit 110 enters the power conversion stage PCS2.

Then, in the power conversion stage PCS2, the micro-controller 122 generates the control signal S4 in the high level H and the control signals S1 through S3 in the low level L, such that the transistor Q4 is switched on in response to the control signal S4, and the transistor Q1 through Q3 are switched off in response to the control signals S1 through S3.

In the equivalent circuit configuration in this stage, the switched-off transistor Q2 may be equivalent to a capacitor C_{Q2} and an intrinsic body diode D_{Q2} connected in parallel. Therein, the intrinsic body diode D_{Q2} is established based on a diode characteristic of a body of the transistor Q2, and an anode and a cathode and of the intrinsic body diode D_{Q2} are equivalently coupled to the source and the drain of the of the transistor Q2 respectively.

Therefore, in the power conversion stage PCS2, the magnetizing inductor Lr of the inverting circuit 110 discharges the electric energy to the capacitor C_{Q2}, such that a cross-voltages between the drain and the source of the transistor Q2 are gradually reduced.

In the present embodiment, the micro-controller 122 switches the control signal S2 to be in the high level H after a preset time period (which is set as a time period from the time point t1 to a time point t2), such that the inverting circuit 110 enters the power conversion stage PCS3. The preset time period may be set to have a time length which is sufficient for the cross-voltages between the drain and the source of the transistor Q2 dropping down to 0V, and thus, the cross-voltages between the drain and the source of the transistor Q2 already drops down to 0V before the micro-controller 122 switches the control signal S2 to be in the high level H, such that the transistor Q2 can achieve the ZVS.

In the power conversion stage PCS3, the micro-controller 122 generates the control signals S2 and S4 in the high level H and the control signals S1 and S3 in the low level L, such that the transistors Q2 and Q4 are switched on in response to the control signals S2 and S4, and the transistors Q1 and Q3 are switched off in response to the control signals S1 and S3.

In the equivalent circuit configuration in this stage, the magnetizing inductor Lr continues to discharges the electric energy in response to a current path established between the switched-on transistors Q2 and Q4, such that the forward-direction inductive current I_{L}/magnetizing current I1 continuously drops down, and after the inductive current I_{L}/magnetizing current I1 drops down to zero current, the storage capacitor Cr discharges based on the electric energy stored therein, such that the magnetizing inductor Lr stores energy reversely to generate the reverse-direction inductive current I_{L}/magnetizing current I1. At this time, the reverse-direction inductive current I_{L}/magnetizing current I1 are gradually reduced, such that the current-indicating voltage Vi1 rises as the magnetizing current I1 drops down. The comparator 124_2 continuously compares the current-indicating voltage Vi1 with the preset voltage Vref2, so as to determine whether the reverse magnetizing current I1 is greater than the preset current Irp.

When determining that the reverse magnetizing current I1 is greater than the preset current Irp according to the comparison signal Sc2 at a time point t3, the micro-controller 122 switches the control signal S2 to be in the low level L, such that the inverting circuit 110 enters the power conversion stage PCS4.

In the power conversion stage PCS4, the micro-controller 122 generates the control signal S4 in the high level H and the control signals S1 through S3 in the low level L, such that the transistor Q4 is switched on in response to the control signal S4, and the transistor Q1 through Q3 are switched off in response to the control signals S1 through S3.

In the equivalent circuit configuration in this stage, the switched off transistor Q1 may be equivalent to a capacitor C_{Q1} and an intrinsic body diode D_{Q1} connected in parallel. Therein, the intrinsic body diode D_{Q1} is established based on a diode characteristic of a body of the transistor Q1, and an anode and a cathode and of the intrinsic body diode intrinsic body diode D_{Q1} are equivalently coupled to the source and the drain of the of the transistor Q1 respectively.

In the power conversion stage PCS4, the magnetizing inductor Lr in the inverting circuit 110 discharges the electric energy to the capacitor C_{Q2}. A cross-voltage between the drain and the source of the transistor Q1 is gradually reduced in response to the reverse-direction inductive current I_{L}.

In the present embodiment, the zero-voltage detection unit 118 implements the detection of the cross-voltages between the drains and the sources of the transistor Q1 and Q3 by utilizing the structure formed by the detection capacitors Czd1 and Czd2 and the resistors R3 through R6. Taking the transistor Q1 as an example, the detection capacitor Czd1 is charged in response to a change in the cross-voltage between the drain and the source of the transistor Q1, so as to generate the detection current Izd1. The detection current Izd1 raises as the cross-voltage between the drain and the source of the transistor Q1 drops, which causes the current-indicating voltage Vzd1 to rise.

The comparator 124_3 receives the current-indicating voltage Vzd1 and compares it with the preset voltage Vref3, such that the micro-controller 122 may determine whether the current-indicating voltage Vzd1 generated by the detection current Izd1 is greater than the preset voltage Vref3 according to the comparison signal Sc3. When the micro-controller 122 determines that the current-indicating voltage Vzd1 is greater than the voltage Vref3 according to the comparison signal Sc3 (at a time point t4), it represents that the cross-voltage between the drain and the source of the transistor Q1 already drops down to 0V, and the inductive current I_{L} is discharged to zero current. Thus, the micro-controller 122 switches the control signal S1 to be enabled in the zero voltage scenario, such that the inverting circuit 110 returns to the power conversion stage PCS1 and re-performs the circuit operations in the power conversion stages PCS1 through PCS4 illustrated in FIG. 3A through FIG. 3D.

It should additionally mentioned that the embodiment above is illustrated for the power conversion operation of the AC output voltage Vac in the positive half cycle PHP. However, it should be understood to the persons of the art that based on the premise of the inverting circuit 110 being symmetrically configured, the power conversion operation in a negative half cycle NHP is achieved only by means of symmetrically adjusting the control signals S1 through S4 applied to the first bridge arm unit 112 and second bridge arm unit 114 in each of the power conversion stages PCS1 through PCS4. In the power conversion stage PCS4 during the negative half cycle NHP, the circuit operation performed by the comparator 124_3 correspondingly changes to be performed by the comparator 124_4 according to the current-indicating voltage Vzd2 and the preset voltage Vref4. Being similar to the operation in the power conversion stage PCS4, in the power conversion stage PCS4 during the negative half cycle NHP, the micro-controller 122 may determine whether the current-indicating voltage Vzd2 generated by the detection current Izd2 is greater than the preset voltage Vref4 according to the comparison signal Sc4, so as to adjust the disable/enable states of the control signals S1 through S4.

Table (2) below summaries the disable/enable states of the control signals S1 through S4 in each of the power conversion stages PCS1 through PCS4 during the negative half cycle NHP. The specific circuit operation may refer to the description related to the embodiment above with reference to Table (2) and thus, will not be repeatedly described.

TABLE (2)

| | PCS1 | PCS2 | PCS3 | PCS4 |
|---|---|---|---|---|
| S1 (Q1) | L | L | L | L |
| S2 (Q2) | H | H | H | H |
| S3 (Q3) | H | L | L | L |
| S4 (Q4) | L | L | H | L |

Accordingly, by means of the control operations, either in the positive half cycle PHP or in the negative half cycle NHP, the on-state of each of the transistors Q1 through Q4 is switched when having zero voltage, such that the ZVS control may be achieved, and the overall power conversion operation of the inverting circuit 110 may have characteristics of high conversion efficiency.

In light of the foregoing, the inverting apparatus provided by the embodiments of the invention can determine whether the magnetizing currents flowing through each bridge arm reaches the preset positive current peak or the preset reverse current peak, so as to adjust the switch timing of the control signals. Thus, each transistor in the inverting circuit can achieve the ZVS, and the inverting circuit can be operated in the BCM for the power conversion. Therefore, based on the premise that the circuit structure does not need any change, the inverting apparatus can achieve the enhancement of the conversion efficiency of the inverting apparatus 110 only by means of the control circuit 120 regulating the circuit operations of the inverting circuit 110.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. An inverting apparatus, comprising:
an inverting circuit, having a first bridge arm unit, a second bridge arm unit and an energy charging/discharging unit, the energy charging/discharging unit is coupled between the first bridge arm unit and the second bridge arm unit, and the energy charging/discharging unit is adapted to connect an electrical grid in parallel, so as to provide an AC output voltage,
wherein the first bridge arm unit and the second bridge arm unit receive a DC input voltage, the first bridge arm unit is switched according to a first control signal and a second control signal, and the second bridge arm unit is switched according to a third control signal and a fourth control signal, so as to convert the DC input voltage into the AC output voltage; and
a control circuit, coupled to the inverting circuit and configured to provide the first through the fourth control signals to control power conversion of the inverting circuit,
wherein the control circuit samples a first magnetizing current flowing through the first bridge arm unit and a second magnetizing current flowing through the second bridge arm unit to adjust switch timing of the first through the fourth control signals, such that the inverting circuit is operated on a boundary conduction mode (BCM).

2. The inverting apparatus according to claim 1, wherein the control circuit determines whether the first magnetizing current reaches a preset reverse current peak, and the second magnetizing current reaches a preset positive current peak, so as to adjust the switch timing of the first through the fourth control signals according to the determination result.

3. The inverting apparatus according to claim 1, wherein the inverting circuit comprises:
a first transistor, having a first terminal receiving the DC input voltage and a control terminal receiving the first control signal;
a second transistor, having a first terminal coupled to a second terminal of the first transistor and a control terminal receiving the second control signal;
a first resistor, having a first terminal coupled to a second terminal of the second transistor and a second terminal coupled to a ground terminal, wherein the first transistor, the second transistor and the first resistor form the first bridge arm unit, and a current flowing through the first resistor is defined as the first magnetizing current;
a third transistor, having a first terminal receiving the DC input voltage and a control terminal receiving the third control signal;
a fourth transistor, having a first terminal coupled to a second terminal of the third transistor and a control terminal receiving the fourth control signal;
a second resistor, having a first terminal coupled to a second terminal of the fourth transistor and a second terminal coupled to the ground terminal, wherein the third transistor, the fourth transistor and the second resistor form the second bridge arm unit, and a current flowing through the second resistor is defined as the second magnetizing current;
a magnetizing inductor, having a first terminal coupled to the second terminal of the first transistor and the first terminal of the second transistor; and
a storage capacitor, having a first terminal coupled to a second terminal of the magnetizing inductor and a second terminal coupled to the second terminal of the third transistor and the first terminal of the fourth transistor, wherein the magnetizing inductor and the storage capacitor form the energy charging/discharging unit,
wherein on-states of the first through the fourth transistors are switched respectively in response to the received first through fourth control signals, such that the magnetizing inductor and the storage capacitor store or release electric energy in response to the switching of the first through the fourth transistors, so as to generate the AC output voltage at the two terminals of the storage capacitor.

4. The inverting apparatus according to claim 3, wherein the control circuit comprises:
a micro-controller, configured to generate the first through the fourth control signals and switch disable/enable states of the first through the fourth control signals according to a first comparison signal and a second comparison signal;
a first comparator, having a first input terminal coupled to the first terminal of the first resistor and the first terminal of the second resistor, a second input terminal receiving a first preset voltage indicating a first preset current and an output terminal outputting the first comparison signal, wherein the first comparison signal indicates a result of comparing the first magnetizing current with the first preset current or a result of comparing the second magnetizing current with the first preset current; and
a second comparator, having a first input terminal coupled to the first terminal of the first resistor and the first terminal of the second resistor, a second input terminal receiving a second preset voltage indicating a second preset current, and an output terminal outputting the second comparison signal, wherein the second comparison signal indicates a result of comparing the first magnetizing current with the second preset current or a result of comparing the second magnetizing current with the second preset current.

5. The inverting apparatus according to claim 4, wherein the inverting circuit further has a zero-voltage detection unit, and the zero-voltage detection unit comprises:
a first detection capacitor, having a first terminal coupled to the second terminal of the first transistor, the first terminal of the second transistor and the first terminal of the magnetizing inductor;
a third detection capacitor, having a first terminal coupled to a second terminal of the first detection capacitor; and
a fourth detection capacitor, having a first terminal coupled to a second terminal of the third detection capacitor and a second terminal coupled to the ground terminal, wherein the a current flowing through the fourth detection capacitor is defined as a first detection current.

6. The inverting apparatus according to claim 5, wherein the zero-voltage detection unit further comprises:
a second detection capacitor, having a first terminal coupled to the second terminal of the third transistor, the first terminal of the fourth transistor and a second terminal of the storage capacitor;
a fifth resistor, having a first terminal coupled to a second terminal of the second detection capacitor; and
a sixth resistor, having a first terminal coupled to a second terminal of the fifth resistor and a second terminal coupled to the ground terminal, wherein a current flowing through the sixth resistor is defined as a second detection current.

7. The inverting apparatus according to claim 6, wherein the micro-controller further switches the disable/enable states of the first through the fourth control signals according to a third comparison signal and a fourth comparison signal, and the control circuit further comprises:
a third comparator, having a first input terminal coupled to the first terminal of the fourth detection capacitor, a second input terminal receiving a third preset voltage indicating a third preset current, and output terminal outputting the third comparison signal, wherein the third comparison signal indicates a result of comparing the first detection current with the third preset current; and
a fourth comparator, having a first terminal coupled to the first terminal of the sixth resistor, a second input terminal receiving a fourth preset voltage indicating a fourth preset current and an output terminal outputting the fourth comparison signal, wherein the fourth comparison signal indicating a result of comparing the second detection current with the fourth preset current.

8. The inverting apparatus according to claim 7, wherein when the inverting circuit is operated in a first power conversion stage, the micro-controller generates the enabled first and fourth control signals and the disabled second and third control signals, so as to switch on the first and the fourth transistors and switch off the second and the third transistors,
wherein when determining that the first magnetizing current or the second magnetizing current is greater than the first preset current according to the first comparison signal, the micro-controller switches the first control signal to be disabled, such that the inverting circuit enters a second power conversion stage.

9. The inverting apparatus according to claim 8, wherein when the inverting circuit is operated in the second power conversion stage, the micro-controller generates the enabled fourth control signal and the disabled first through third control signals, so as to switch on the fourth transistor and switch off the first through the third transistors,
wherein the micro-controller switches the second control signal to be enabled after a preset time period, such that the inverting circuit enters a third power conversion stage.

10. The inverting apparatus according to claim 9, wherein when the inverting circuit is operated in the third power conversion stage, the micro-controller generates the enabled second and fourth control signals and the disabled first and third control signals, so as to switch on the second and the fourth transistors and switch off the first and the third transistors,
wherein when determining that the first magnetizing current or the second magnetizing current is greater than the second preset current according to the second comparison signal, the micro-controller switches the second control signal to be disabled, such that the inverting circuit enters a fourth power conversion stage.

11. The inverting apparatus according to claim 10, wherein when the inverting circuit is operated in the fourth power conversion stage, the micro-controller generates the enabled fourth control signal and the disabled first through third control signals, so as to switch on the fourth transistor and switch off the first through the third transistors,
wherein when determining that the first detection current is greater than the third preset current according to third comparison signal, the micro-controller switches the first control signal to be enabled, such that the inverting circuit enters the first power conversion stage.

12. The inverting apparatus according to claim 11, wherein the first through the fourth transistors are controlled by the micro-controller control to switch the on state when having zero voltage.
